(19) United States
(12) Patent Application Publication
(10) Pub. No.: US 2026/0237736 A1
(43) Pub. Date: Aug. 13, 2026

(54) SOLID ELECTROLYTE AND ELECTRODE FOR A SOLID-STATE BATTERY, AND A METHOD FOR PRODUCING THE SAME

(71) Applicants: SOLITHOR, Slnt-Truiden (BE); IMEC, Leuven (BE)

(72) Inventors: Walid ALKARMO, Jupille-sur-Meuse (BE); Fanny BARDE, Holsbeek (BE)

(21) Appl. No.: 19/150,669

(22) PCT Filed: Jan. 27, 2023
(86) PCT No.: PCT/EP2024/051857

§ 371 Date: Jul. 24, 2025

(30) Foreign Application Priority Data
Jan. 27, 2023 (EP) 23153655.8

(51) Int. Cl. H01M 10/0565; H01M 10/052

(52) U.S. Cl. CPC H01M 10/0565; H01M 10/052; H01M 2300/0082; H01M 2300/0085; H01M 2300/0091

(57) ABSTRACT

The technology of the present disclosure generally relates to the field of power storage devices, and more specifically to a solid electrolyte, an electrode, a solid-state battery, and a method for producing the same. The solid electrolyte of the present disclosure comprises a porous composite network network obtained by a reaction of an alkoxide compound and a polymer precursor compound; wherein the alkoxide compound is selected from the group consisting of silica alkoxide, alumina alkoxide, zirconium alkoxide, and mixtures thereof; wherein the polymer precursor compound comprises two functional end groups of which at least one functional end group is selected from the group consisting of alkoxysilane, alkoxy aluminium, alkoxy zirconium, and combinations thereof; wherein the polymer precursor compound comprises polyethylene glycol (PEG) and/or polytetrahydrofuran (PTHF); wherein the porous composite network is functionalised with an electrolyte comprising an ionically conductive compound in which a metal salt is dissolved; and wherein the porous composite network comprises clay mineral particles, preferably clay mineral nanoparticles.

### FIELD OF THE INVENTION

The technology of the present disclosure generally relates to the field of power storage devices, and more specifically to a solid electrolyte, an electrode, a solid-state battery, and a method for producing the same.

### BACKGROUND

Electrochemical power storage devices are widely used in transport applications ranging from automotive to aviation, marine to space. A conventional liquid electrolyte, however, is flammable and volatile, which adds risk of fire when leakage happens. The development of solid-state batteries containing a solid electrolyte is therefore becoming increasingly important, especially with the ever-increasing demand for high energy and safety. In the pursuit of a solid electrolyte having desirable properties, several types of materials have been considered, including organic or inorganic nature such as ceramics, polymers, gels electrolytes, and so on.

Sol-gel chemistry with polymers is an important technique to incorporate highly cross-linked inorganic networks into organic polymeric matrices. Advantages of sol-gel reactions in polymer technology are the easy fabrication, low cost of the chemicals, their versatility, preparation under mild conditions (that is, at low temperature and ambient atmosphere), possibility of coating on substrates of any size and over large areas, cheap and well-known technologies for application. In this method, hydrolysis and polycondensation reactions of alkoxysilane monomers containing a polymerizable organic moiety covalently attached to the silicon and the subsequent polymerization of the organic moiety take place to form connectivity between the organic phase and the inorganic network.

Efforts have been made to utilise silica electrolytes for a lithium battery. For example, European Patent No. EP 3 706 226 describes the use of nanocomposites consisting of a mesoporous silica with an ionic liquid electrolyte filler as solid electrolyte for lithium battery. However, due to the absence of the flexibility in the pure inorganic glass network, cracks can develop in the coating film as the brittle silica network is unable to accommodate the stress that is generated during the coating process. This limits the use of mesoporous silica as an electrolyte in a battery system.

The use of various additives has nonetheless been proposed to improve the ionic conductance of silica electrolytes. For example, European Patent No. EP 3 780 163 describes the formation of a polymer polarization layer adsorbed to the inner surface of the pores of a porous silica matrix. Although an improvement of ionic conductance has been reported, the inclusion of such additives fails to address the mechanical brittleness of the silica matrix.

Indeed, stress cracking severely limits the range of applications for which the sol-gel process can be used, making the fabrication of large monolithic glasses and thick self-standing films impossible. As such, obtaining a crack-free film of few μm (for example, in a range of >20 μm & <150 μm on top of the electrode) without adding an extra membrane to provide mechanical strength, reveals to be very difficult based on a pure silica matrix.

US 2013/0209893 A1 relates to nanoparticle organic hybrid materials (NOHMs), methods of making NOHMs, and compositions containing NOHMs. The individual NOHMs comprise a silica core and an organic polymeric corona or arm attached to an inorganic nanoparticle core.

KR 20150061538 A relates to a support prepared from a resin composition containing a polymer formed by branching a block copolymer comprising a polypropylene oxide block and a polyethylene oxide block; an electrolyte membrane comprising the support and the ion conductive electrolyte supported on the support; a method of producing the electrolyte membrane; and a battery and an ultra-high capacity capacitor including the electrolyte membrane.

Velez John Fredy et al is directed to organic-inorganic hybrid solid electrolytes based on silica-polyethylene glycol PEG (200,400) with bis(trifluoromethane)sulfonimide lithium salt (LiTFSI) or lithium trifluoromethanesulfonate (LiOTf) synthesised by a sol-gel process.

WO 2018/071322 A1 relates to a composite material including a ceramic portion, a metal oxide portion, and a coupling agent portion, wherein the coupling agent is covalently bonded to the metal oxide; and a method for making said composite material.

None of these documents adequately address the above limitations of current battery technology. Hence, there is a need to remedy these limitations by providing for a solid electrolyte that has improved mechanical properties, without reducing and advantageously even improving the ionic conductance of said solid electrolyte, which is necessary for development of commercially relevant solid-state batteries.

### SUMMARY OF THE INVENTION

The technology of the present disclosure generally relates to the field of power storage devices, and more specifically to a solid electrolyte comprising a porous network that is doped with an ionically conductive compound. The porous network may comprise silica and a functionalised polymer, whereby the polymer forms a plurality of chains that are covalently grafted within the silica network such that a porous composite network is formed.

The herein disclosed composite porous network can be produced by mixing one or more alkoxide compounds, preferably silica precursors with one or more functionalised polymer precursors, for example, using a sol-gel process. The in-situ formation of a composite porous network can improve the flexibility and integrity of the solid electrolyte. Specifically, the composite network can reduce stress cracking during the curing process allowing the possibility of coating on substrates of larger size and/or over large areas.

It should be appreciated that, although the possibility of using polymer additives has been previously considered, for example, in European Patent no. EP 3 780 163, to form a superficial layer, they fail to improve the mechanical properties of the solid electrolyte. To elaborate, the polymer chains of additives are adsorbed on the surface of the porous silica and not covalently attached with the silica network, which lead to formation of polymer aggregates and inhomogeneous dispersion of polymer in silica matrix. As a result, the polymer cannot improve the flexibility of electrolyte and avoid the development of cracks in the coating film.

This in contrast to the herein disclosed composite porous network, in which the polymer chains form an integral part of the composite network network. Therefore, they may enhance, inter alia, the mechanical properties of the solid electrolyte (for example, improved resilience and flexibility), contribute to the improvement of ionic properties (such as enhanced ionic conductivity through optimized lithium-ion transport paths) and/or thermal properties (for example, reduced thermal degradation), as discussed later. Indeed, the presence of integrated polymer chains can lead to strong dissociation of the lithium salts, thereby improving the ion conductivity of the solid electrolyte that makes it particularly suitable for manufacturing of a high energy solid-state battery. Silane terminated groups provide further mechanical compliance and structural integrity under compression process, strengthening the electrolyte backbone. Also, in a particular embodiment the solid electrolyte may comprise clay mineral particles that can improve the lithium ionic conductivity and Lithium-ion transference number for electrolytes. The provision of clay mineral nanoparticles, such as halloysite nanotubes (HNT), offers further advantages to obtain a homogenous dispersion in a (covering/coating) layer, for example, formed on the electrode active material. Without wishing to be bound by theory, it has been found that the opposite surface charge on the halloysite separate lithium salt into Li cations that are absorbed on the outer negatively charged silica surface of HNT, and anions of lithium salt are expected to be adsorbed at the inner, positively charged aluminol surface of HNT. As such, the electrochemical and thermal stability can be enhanced further by adding HNT. Also, the HNT can improve the mechanical strength of the solid electrolyte.

An overview of various aspects of the technology of the present disclosure is given hereinbelow, after which specific embodiments will be described in more detail. This overview is meant to aid the reader in understanding the technological concepts more quickly, but it is not meant to identify the most important or essential features thereof, nor is it meant to limit the scope of the present disclosure, which is limited only by the claims.

An aspect of the present disclosure relates to a solid electrolyte for an electrochemical energy storage device, comprising a porous composite network comprising silica and a silane terminated polymer; whereby said silica and polymer are covalently grafted within said network; and, wherein said network is functionalised with an electrolyte comprising an ionically conductive compound in which a metal salt is dissolved.

A further aspect of the present disclosure relates to a solid electrolyte for an electrochemical energy storage device, comprising a porous composite network obtained by a reaction of an alkoxide compound and a polymer precursor compound;
wherein the alkoxide compound is selected from the group consisting of silica alkoxide, alumina alkoxide, zirconium alkoxide, and mixtures thereof;
wherein the polymer precursor compound comprises at least one functional end group selected from the group consisting of alkoxysilane, alkoxy aluminium, alkoxy zirconium, and combinations thereof; wherein the polymer precursor compound comprises polyethylene glycol (PEG) and/or polytetrahydrofuran (PTHF);
wherein the porous composite network is functionalised with an electrolyte comprising an ionically conductive compound in which a metal salt is dissolved; and
wherein the porous composite network comprises clay mineral particles, preferably clay mineral nanoparticles.

In some embodiments the porous composite network comprises natural clay mineral particles, preferably natural clay mineral nanoparticles.

In some embodiments the polymer precursor compound comprises at least two functional end groups, of which at least one functional end group is selected from the group consisting of alkoxysilane, alkoxy aluminium, alkoxy zirconium, and combinations thereof.

In some embodiments, the clay mineral particles are nanoparticles with an elongated shape, preferably including nanowires, nanofibers, nanowires, nanotubes, and/or nanorods.

In some embodiments, the clay mineral particles comprises nanostructures with a tubular shape having a negatively charged exterior and a positively charged interior.

In some embodiments, the clay mineral particles comprises nanostructures with a tubular shape having a hollow interior.

In some embodiments, the clay mineral particles are selected from the group consisting of palygorskite, attapulgite, kaolin, smectite, illite, chlorite, sepiolite, vermiculite, and mixtures thereof; preferably palygorskite, kaolin and/or attapulgite.

In certain embodiments, the silica alkoxide is selected from the group consisting of tetraethyl orthosilicate (TEOS), tetramethyl orthosilicate (TMOS), triethylvinylorthosilcate (VTEOS), or substitutions thereof, and/or a combination thereof.

In certain embodiments, the alumina alkoxide is selected from the group consisting of aluminium triethoxide, aluminium trimethoxide, aluminium triisopropoxide, or substitutions thereof, and/or a combination thereof.

In certain embodiments, the zirconium alkoxide is selected from the group consisting of zirconium tetraethoxide, zirconium tetramethoxide, zirconium tetraisopropoxide, or substitutions thereof, and/or a combination thereof.

In preferred embodiments, the porous composite network is an inorganic-organic hybrid network, preferably comprising a copolymer of the alkoxide compound and the polymer precursor compound.

In some embodiments the polymer comprises polyethylene glycol (PEG) and/or polytetrahydrofuran (PTHF).

In some embodiments the polymer comprises a mono- and/or bi-terminal reactive functional group, preferably wherein the polymer precursor compound comprises one and/or two reactive functional end groups.

In some embodiments the polymer comprises alkoxysilane and/or alkoxy aluminium as terminal reactive functional group.

In some embodiments the solid electrolyte comprises halloysite nanotubes (HNT); preferably aluminosilicate (Al₂Si₂O₅(OH)₄) nano-clay.

In some embodiments, the clay mineral particles comprise halloysite nanotubes (HNT) comprising aluminosilicate (Al₂Si₂O₅(OH)₄).

In some embodiments the amount of clay mineral particles or nanoparticles is at least 0.1 wt. % to at most 10 wt. % with respect to the total weight of the solid electrolyte, preferably at least 0.5 wt. % to at most 10 wt. % with respect to the total weight of the solid electrolyte, more preferably at least 1.0 wt. % to at most 10 wt. % with respect to the total weight of the solid electrolyte.

In some embodiments the amount of HNT is at least 0.1 wt. % to at most 10 wt. % with respect to the total weight of the solid electrolyte, preferably at least 0.5 wt. % to at most 10 wt. % with respect to the total weight of the solid electrolyte, more preferably at least 1.0 wt. % to at most 10 wt. % with respect to the total weight of the solid electrolyte.

Another aspect of the present disclosure relates to an electrode comprising the solid electrolyte according to any of the above aspects and an electrode active material.

In some embodiments the solid electrolyte forms a covering/coating layer on the electrode active material. Advantageously, the solid electrolyte forms a thin covering/coating layer on the electrode active material.

In some embodiments the covering layer has a layer thickness after drying and before compression of below about 200 μm, more preferably below about 100 μm; more preferably still below about 60 μm.

In some embodiments the covering layer is a uniform and/or homogenous covering layer, without any cracks. Advantageously, the clay mineral particles are uniformly and/or homogenously dispersed in the covering layer.

Another aspect of the present disclosure relates to an electrochemical energy storage device comprising a positive electrode, a negative electrode; and the solid electrolyte according to any of the above aspects.

In some embodiments the solid electrolyte forms an overfill on top of the positive and/or negative electrode.

In some embodiments the solid electrolyte forms an overfill on top of the positive electrode only.

Another aspect of the present disclosure relates to a method for producing a solid electrolyte, comprising at least the steps:
mixing a silica precursor, a silane terminated polymer compound, an ionically conductive compound, a metal salt, and an organic solvent to form a liquid mixture;
causing gelation of the liquid mixture to form a gel mixture; and
drying and/or ageing the gel mixture to form the solid electrolyte.

A further aspect of the present disclosure relates to a method for producing a solid electrolyte, preferably a solid electrolyte as disclosed herein, comprising the steps of:
mixing an alkoxide compound, a polymer precursor compound comprising PEG and/or PTHF, an ionically conductive compound, a metal salt, clay mineral particles, and a solvent to form a liquid mixture;
causing gelation of the liquid mixture to form a gel mixture; and,
drying and/or ageing the gel mixture to form the solid electrolyte.

In some embodiments the polymer compound comprises polyethylene glycol (PEG) and/or polytetrahydrofuran (PTHF).

In some embodiments, the mixing of the silica precursor and the silane terminated polymer precursor comprises comprising covalently bonding said polymer compound to the silica precursor such that a porous composite network is formed, whereby the silica and silane terminated polymer are covalently grafted within said network.

In some embodiments, the polymer compound comprises a mono-terminal reactive functional group according to the following formula:

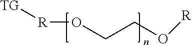

wherein TG is a terminal reactive functional group, preferably alkoxysilane and/or alkoxyalumina, R is an alkyl group, and n ranges from 6 to 1300, preferably 6 to 100, more preferably 6 to 9.

In some embodiments, the polymer precursor compound comprises one reactive functional end group and one non-reactive functional end group according to the following formula:

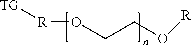

wherein TG is a reactive functional end group selected from the group consisting of alkoxysilane, alkoxy aluminium, alkoxy zirconium, and combinations thereof; R is an alkyl group; and n ranges from 6 to 1300, preferably 6 to 100, more preferably 6 to 9.

In some embodiments, the polymer compound comprises a bi-terminal reactive functional group according to the following formula:

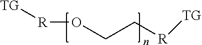

wherein TG is a terminal reactive functional group, preferably alkoxysilane and/or alkoxyalumina, R is an alkyl group, and n ranges from 6 to 13000, more preferably 6 to 1000, more preferably 6 to 150.

In some embodiments, the polymer precursor compound comprises two reactive functional end groups according to the following formula:

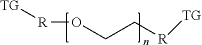

wherein TG is a reactive functional end group selected from the group consisting of alkoxysilane, alkoxy aluminium, alkoxy zirconium, and combinations thereof; R is an alkyl group; and n ranges from 6 to 13000, more preferably 6 to 1000, more preferably 6 to 150.

In some embodiments the polymer compound comprises a combination of two or more polymer compounds; wherein at least one polymer comprises a mono-terminal reactive functional group and at least one polymer comprises a bi-terminal reactive functional group.

In some embodiments, the method as disclosed herein comprises a combination of two or more polymer compounds; wherein at least one polymer comprises one reactive functional end group and one non-reactive functional end group, preferably according to any of the above embodiments, and at least one polymer comprises two reactive functional end groups, preferably according to any of the above embodiments.

In some embodiments the amount of polymer compound is at least 3 wt. % to at most 15 wt. % with respect to the total weight of the solid electrolyte.

In some embodiments

In some embodiments the silica precursor comprises a silicon alkoxide; preferably comprising tetraethyl orthosilicate (TEOS), tetramethyl orthosilicate (TMOS), triethylvinylorthosilcate (VTEOS), or substitutions thereof, and/or a combination thereof.

In some embodiments the liquid mixture comprises halloysite nanotubes (HNT), preferably from aluminosilicate (Al₂Si₂O₅(OH)₄) nano-clay.

In some embodiments the amount of HNT is at least 0.5 wt. % to at most 10 wt. % with respect to the total weight of the solid electrolyte.

### DESCRIPTION OF THE FIGURES

The following description of the figures relate to specific embodiments of the disclosure which are exemplary in nature and not intended to limit the teachings or applications of the present disclosure. Throughout the drawings and their descriptions the following abbreviations are used: silane terminated polyethylene glycol (SPEG); halloysite nanotubes (HNT); tetraethoxysilane (TEOS); 1-ethyl-3-methylimidazolium bis(fluorosulfonyl)imide (EMI-FSI); Lithium bis(trifluoromethane)sulfonimide (TFSI); lithium nickel manganese cobalt oxides (NMC) cathode; lithium ferro-phosphate (LFP); electrochemical impedance spectroscopy (EIS); thermal gravimetric analysis (TGA); scanning electron microscope (SEM).

FIG. 1 shows a graphic representation of an in-situ formation of a composite network comprising silica and silane terminated PEG chains.

FIG. 2 shows a graphic representation of an in-situ formation of a composite network comprising silica, silane terminated PEG chains and HNT.

FIG. 3 shows a dried electrolyte film prepared by drop casting of a pure silica electrolyte.

FIG. 4 shows a dried electrolyte film prepared by drop casting of a composite electrolyte with 5 wt. % SPEG.

FIG. 5 shows a dried electrolyte film prepared by drop casting of a composite electrolyte with 10 wt. % SPEG.

FIG. 6 shows a dried electrolyte self-standing film prepared by drop casting of a composite electrolyte with 5.0 wt. % SPEG.

FIG. 7 shows a dried electrolyte self-standing film prepared by drop casting of a composite electrolyte with 10 wt. % SPEG and 0.5 wt. % HNT.

FIG. 8 shows a 200 μm thick dried electrolyte film prepared by drop casting of a composite electrolyte with 7 wt. % SPEG+1 wt. % HNT on top of a porous composite cathode after bending.

FIG. 9 shows a SEM image for a 14 μm thin dried electrolyte film prepared by blade coating a pure silica electrolyte.

FIG. 10 shows a SEM image for a 78 μm thick dried electrolyte film prepared by blade coating a composite electrolyte with 3 wt. % SPEG.

FIG. 11 shows a SEM image for a 96 μm thick dried electrolyte film prepared by blade coating a composite electrolyte with 10 wt. % SPEG and 3 wt. % HNT.

FIG. 12 shows the ionic conductivity (mS/cm) for electrolyte films prepared by drop casting of a pure silica electrolyte, a composite electrolyte with 5.0 wt. % SPEG, a composite electrolyte with 0.5 wt. % HNT, a composite electrolyte with 7.0 wt. % SPEG and 1.0 wt. % HNT, and a composite electrolyte with 10.0 wt. % SPEG and 0.8 wt. % HNT.

FIG. 13 shows the measured ionic conductivity (mS/cm) for electrolyte films prepared by drop casting of a pure silica electrolyte, a composite electrolyte with 10.0 wt. % SPEG, and a composite electrolyte with 10.0 wt. % SPEG and 0.8 wt. % HNT.

FIG. 14 shows the ionic conductivity (mS/cm) for electrolyte films prepared by drop casting of a pure silica electrolyte and a composite electrolyte with 3.0 wt. % SPEG and 3.0 wt. % HNT in function of different compressive pressure (thickness %).

FIG. 15 shows an electrolyte film prepared by drop casting of a pure silica electrolyte after compression of 40%.

FIG. 16 shows an electrolyte film prepared by drop casting of a composite electrolyte films with 3 wt. % SPEG and 3.0 wt. % HNT after compression of 40%.

FIG. 17 shows the thermal degradations in the temperature range of 0-600° C. for electrolyte films prepared by drop casting a pure silica electrolyte, pure HNT, and a composite electrolyte with 3.0 wt. % HNT.

FIG. 18 shows the thermal degradations in the temperature range of 0-600° C. for electrolyte films prepared by drop casting a pure silica electrolyte, pure HNT, pure SPEG, a composite electrolyte with 5.0 wt. % SPEG, and a composite electrolyte with 5.0 wt. % SPEG and 0.5 wt. % HNT.

FIG. 19 shows the battery charge/discharge voltage curves for the 1st, 2nd and 100th cycle of a full cell produced based on a stack of Li/composite electrolyte with 5.0 wt. % SPEG and 1.0 wt. % HNT/LiFePO₄.

FIG. 20 shows the long-term cycle performance of the battery of FIG. 19 at room temperature.

### DETAILED DESCRIPTION

In the following detailed description, the technology underlying the present disclosure will be described by means of different aspects thereof. It will be readily understood that the aspects of the present disclosure, as generally described herein, and illustrated in the figures, can be arranged, substituted, combined, and designed in a wide variety of different configurations, all of which are explicitly contemplated and make part of this disclosure. This description is meant to aid the reader in understanding the technological concepts more easily, but it is not meant to limit the scope of the present disclosure, which is limited only by the claims.

Reference throughout this specification to “one embodiment” or “an embodiment” means that a particular feature, structure or characteristic described in connection with the embodiment is included in at least one embodiment of the present disclosure. Thus, appearances of the phrases “in one embodiment” or “in an embodiment” in various places throughout this specification are not necessarily all referring to the same embodiment.

As used herein, the terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” when referring to recited members, elements or method steps also include embodiments which “consist of” said recited members, elements or method steps. The singular forms “a”, “an”, and “the” include both singular and plural referents unless the context clearly dictates otherwise.

Objects described herein as being “connected” or “coupled” reflect a functional relationship between the described objects, that is, the terms indicate the described objects must be connected in a way to perform a designated function which may include a direct or indirect connection in a physical or nonphysical manner, as appropriate for the context in which the term is used.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, the term “about” is used to provide flexibility to a numerical value or range endpoint by providing that a given value may be “a little above” or “a little below” said value or endpoint, depending on the specific context. Unless otherwise stated, use of the term “about” in accordance with a specific number or numerical range should also be understood to provide support for such numerical terms or range without the term “about”. For example, the recitation of “about 30” should be construed as not only providing support for values a little above and a little below 30, but also for the actual numerical value of 30 as well.

The recitation of numerical ranges by endpoints includes all numbers and fractions subsumed within the respective ranges, as well as the recited endpoints. Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the disclosure described herein are capable of operation in other sequences than described or illustrated herein.

Reference in this specification may be made to devices, structures, systems, or methods that provide “improved” performance (e.g. increased or decreased results, depending on the context). It is to be understood that unless otherwise stated, such “improvement” is a measure of a benefit obtained based on a comparison to devices, structures, systems or methods in the prior art. Furthermore, it is to be understood that the degree of improved performance may vary between disclosed embodiments and that no equality or consistency in the amount, degree, or realization of improved performance is to be assumed as universally applicable.

An overview of various aspects of the technology of the present disclosure is given hereinbelow, after which specific embodiments will be described in more detail. This overview is meant to aid the reader in understanding the technological concepts more quickly, but it is not meant to identify the most important or essential features thereof, nor is it meant to limit the scope of the present disclosure, which is limited only by the claims. When describing specific embodiments, reference is made to the accompanying drawings, which are provided solely to aid in the understanding of the described embodiment.

In the present description, technology is described by means of which a solid electrolyte can be produced that is suitable for the manufacturing of a (solid-state) battery. More specifically, a solid electrolyte is disclosed comprising a porous network that is doped with an ionically conductive compound. The porous network can comprise silica and a functionalised polymer, whereby said polymer forms a plurality of chains that are covalently grafted within the silica network such that a porous composite network is formed.

In certain embodiments, the porous network can comprise aluminium and a functionalised polymer, whereby said polymer forms a plurality of chains that are covalently grafted within the aluminium network such that a porous composite network is formed.

In certain embodiments, the porous network can comprise zirconium and a functionalised polymer, whereby said polymer forms a plurality of chains that are covalently grafted within the zirconium network such that a porous composite network is formed.

The terms “matrix” and “network” are used herein interchangeably and denote a three-dimensional cross-linked polymeric structure, wherein the polymer chains are bonded together by covalent links. Preferably, the functionalised polymer is a silane terminated polyether, for example, polyethylene glycol (PEG) and polytetrahydrofuran (PTHF). As used herein, a silane terminated polymer refers to polymers terminating with a silyl group. The polymer may advantageously comprise mono- and/or bi-terminal reactive functional groups, for example, alkoxysilane groups.

In some embodiments, the functionalised polymer is an alkoxy aluminium terminated polyether, for example, polyethylene glycol (PEG) and polytetrahydrofuran (PTHF). As used herein, an alkoxy aluminium terminated polymer refers to polymers terminating with an alkoxy aluminium group. The polymer may advantageously comprise mono- and/or bi-terminal reactive functional groups, for example, alkoxy aluminium groups.

In some embodiments, the functionalised polymer is an alkoxy zirconium terminated polyether, for example, polyethylene glycol (PEG) and polytetrahydrofuran (PTHF). As used herein, an alkoxy zirconium terminated polymer refers to polymers terminating with an alkoxy zirconium group. The polymer may advantageously comprise mono- and/or bi-terminal reactive functional groups, for example, alkoxy zirconium groups.

In an aspect of the disclosure, the solid electrolyte for an electrochemical energy storage device, comprises a porous composite network obtained by a reaction of an alkoxide compound and a polymer precursor compound; wherein the alkoxide is selected from the group consisting of silica alkoxide, alumina alkoxide, zirconium alkoxide, and mixtures thereof; wherein the polymer precursor compound comprises two functional end groups selected from the group consisting of alkoxysilane, alkoxy aluminium, alkoxy zirconium, and combinations thereof; wherein said polymer precursor compound comprises polyethylene glycol (PEG) and/or polytetrahydrofuran (PTHF); wherein said porous composite network is functionalised with an electrolyte comprising an ionically conductive compound in which a metal salt is dissolved; and preferably, wherein the porous composite network comprises clay mineral particles, preferably clay mineral nanoparticles.

The person skilled in the art understands that the configuration of the polymer precursor compound is adapted to match the alkoxide compound for initiating polymerization. Specifically, the polymer precursor compound can include at least alkoxysilane as a functional end group when the alkoxide compound comprises silica alkoxide, at least alkoxy aluminum when the alkoxide compound comprises alumina alkoxide, and/or at least alkoxy zirconium when the metal comprises zirconia alkoxide.

The herein disclosed porous composite network can be produced through the reaction of an alkoxide compound and a polymer precursor compound, preferably a silica precursor with a polymer precursor comprising a silane terminal reactive functional groups, for example, by a sol-gel process as described later, in order to form an in-situ porous silica network that is covalently grafted with the functionalised polymer chains.

The term “in-situ” as used herein denotes that the porous network is an inorganic-organic hybrid network comprising inorganic segments and organic segments that are comprised in the backbone and/or sidechains of the cross-linked polymeric structure. Hence, the functionalised polymer chains may be incorporated (i.e., covalently bound) into the polymer backbone and/or sidechains. The in-situ formation of the composite porous network can improve the flexibility of the solid electrolyte. Specifically, the presence of functionalised polymer chains grafted inside the silica may allow the composite network to reorganize and fill the solvent place when it is evaporated and form a uniform electrolyte film free of cracks. Hence, allowing the possibility of coating on substrates of any size and over large areas.

In particular embodiments, the porous composite network is an inorganic-organic hybrid network, preferably comprising a copolymer of the alkoxide compound and the polymer precursor compound.

The term “copolymer” as used herein refers to polymers formed by the polymerization of at least two different monomers or macromers. Copolymers can be linear and nonlinear (i.e., branched) depending on the number of reactive functional groups present in each monomer. Typically, monomers having two functional groups mainly result in linear copolymers, while monomers having more than two functional groups mainly yield branched copolymers. When the polymer chains of the branched copolymers become covalently bound (beyond the gel point), a three-dimensional cross-linked network is typically formed.

It should be understood that the herein disclosed monomers (i.e., an alkoxide compound and a polymer precursor compound) typically comprise more than two reactive functionalities, allowing the formation of branched copolymeric structures.

In some embodiments, the porous composite network may comprise branched copolymers, and more particularly graft copolymers, wherein the main chain primarily comprises (inorganic) silica, and wherein the side chains primarily comprises the functionalized (organic) polymer chains.

The formed polymer chains are part of functionalised compound that can be included as a second silica precursor (i.e., monomer) in the electrolyte system. As a result, when the composite network is formed, the polymer chains can be grafted directly within the porous silica that can improve the material flexibility, help to control rheological properties and to reduce hardness in highly filled silica system, such that a uniform electrolyte film can be formed free of cracks, as described later. Moreover, the composite network can act as a reinforcing agent, providing further mechanical compliance and structural integrity under compression process, heat distortion temperature, plateau modulus and lower thermal expansion coefficient to the polymer, that is, due to volume variation taking place upon cycling (for example, when lithium is used as anode).

In this way, a combination of a functionalised polymer with the inorganic composite network is obtained that can provide flexibility and reduce the brittleness that is specific to pure inorganic glasses. This combination could help prevent stress cracking during the curing process allowing the possibility of coating on substrates of over large areas. In comparison, for silica particles, such as those described in the above referenced document, any additional polymers are only grafted at the surface of the composite network, hence essentially forming a “coating” on the inside of the pores of the composite network.

This has the advantage that the present invention allows to introduce grafted polymeric structures both at the surface and in the bulk of the porous composite network, resulting in a more homogeneous distribution of inorganic segments (e.g., providing strength) and organic segments (e.g., providing flexibility, and optimizing the lithium-ion transport path) across and within the porous structure.

Also, the presence of functionalised polymer chains can lead to strong dissociation of the dissolved metal salts, allowing ions to diffuse inside porous silica due to the strong interaction between oxygen atoms of the polymer and ion, resulting in a more relaxed coordination between oxygen atoms and lithium ions and thereby facilitating the transport of ions through the composite network which can improve the ion conductivity of the solid electrolyte so that it is suitable for manufacturing of a high energy solid-state battery, as described later.

The term “solid” as used herein refers to being in solid state as a whole system at room temperature. Partial inclusion of a liquid is not excluded. Gels, for example, are considered “solid”. Hence, the “solid electrolyte” as disclosed herein refers to the electrolyte being in solid state at room temperature so that it is suitable for producing of a solid-state battery. Alternatively or in combination, the electrolyte can be referred to as a “composite electrolyte” based on the combination of constituent materials, more specifically, a combination of the composite network and the functionalised polymer.

In preferred embodiments, the composite network comprises porous silica. The porous silica can be, for example, mesoporous silica. The porous silica may have a porosity in the range of 25% to 90%. The porous silica can have a plurality of pores interconnected mutually. The plurality of pores can also be referred to as continuous pores. Incidentally, the plurality of pores may include an isolated pore. The porous composite network is functionalised with an electrolyte as will be discussed later, which may at least partially fill the interior of the plurality of pores, or may completely fill the interior of the plurality of pores. The diameter of each pore of the porous silica is, for example, in the range of 2 nm to 100 nm.

The term “alkoxide” as used herein may refer to a metal alkoxide (e.g., alumina alkoxide or zirconium alkoxide) and/or a metalloid alkoxide (e.g., silica alkoxide). The alkoxide as described herein may be represented by the following formula (I) or (II):

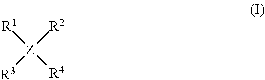

wherein Z is selected from the group consisting of silicon or zirconium; wherein R¹, R², R³, and R⁴ are each independently selected from the group consisting of alkyl or alkoxy, preferably wherein at least three of R¹, R², R³, and R⁴ are alkoxy;

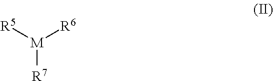

wherein Z is selected from the group consisting of silicon or zirconium; wherein R⁵, R⁶, and R⁷ are alkoxy.

It should be noted that for the formation of the porous composite network as described herein, alkoxy groups are reactive functional groups that can participate in the network formation. Alkyl groups typically do not participate in the network formation, resulting in unreacted, dangling chain ends within the polymeric structure.

In preferred embodiments, the silica alkoxide is selected from the group consisting of tetraethyl orthosilicate (TEOS), tetramethyl orthosilicate (TMOS), triethylvinylorthosilcate (VTEOS), or substitutions thereof, and/or a combination thereof.

In preferred embodiments, the alumina alkoxide is selected from the group consisting of aluminium triethoxide, aluminium trimethoxide, aluminium triisopropoxide, or substitutions thereof, and/or a combination thereof.

In preferred embodiments, the zirconium alkoxide is selected from the group consisting of zirconium tetraethoxide, zirconium tetramethoxide, zirconium tetraisopropoxide, or substitutions thereof, and/or a combination thereof.

The terms “functional end group”, “reactive end group”, and “terminal reactive group” as used herein refers to a substituent or moiety that is positioned at an extremity of a macromolecule or oligomer molecule (e.g., a polymer precursor compound). Said substituent or moiety is capable of entering into further polymerization or other reactions. A polymer functionalized with at least one reactive group is therefore suitable for reaction with a given compound, bearing at least one complementary reactive functional group.

Preferably, in the present disclosure, silica alkoxide is reacted with a polymer precursor compound comprising two alkoxysilane end groups; alumina alkoxide is reacted with a polymer precursor compound comprising two alkoxy aluminium end groups; and zirconium alkoxide is reacted with a polymer precursor compound comprising two alkoxy zirconium end groups.

In certain embodiments, the polymer precursor compound comprises one and/or two reactive functional end groups.

In an embodiment, the solid electrolyte may comprise a porous composite network comprising silica and a silane terminated polyethylene glycol (PEG), whereby said silica and PEG are covalently grafted within said network such that the PEG chains are covalently grafted within the silica. PEG has an ethylene oxide group that is advantageous for a solid electrolyte due to its higher ionic conductivity for ions. Preferably, PEG comprises mono- and/or bi-terminal reactive functional groups, for example, alkoxysilane as a terminal reactive functional group.

In an embodiment, the solid electrolyte may comprise a porous composite network comprising silica and polytetrahydrofuran (PTHF), whereby said silica and PTHF are covalently grafted within said network such that the PTHF chains that are covalently grafted within the silica. PTHF has an ethylene oxide group that is advantageous for a solid electrolyte due to its higher ionic conductivity for ions. Preferably, PTHF comprises mono- and/or bi-terminal reactive functional groups, for example, alkoxysilane as a terminal reactive functional group.

In some embodiments, the amount of silane terminated polymer, preferably PEG and/or PTHF, is at least 1 wt. % to at most 15 wt. % with respect to the total weight of the solid electrolyte. The listed amounts are optimal for improving the flexibility of the solid electrolyte with the silane terminated polymer.

In some embodiments, the solid electrolyte may comprise a porous composite network comprising silica, PEG and PTHF, whereby the PEG and PTHF chains are covalently grafted within the silica.

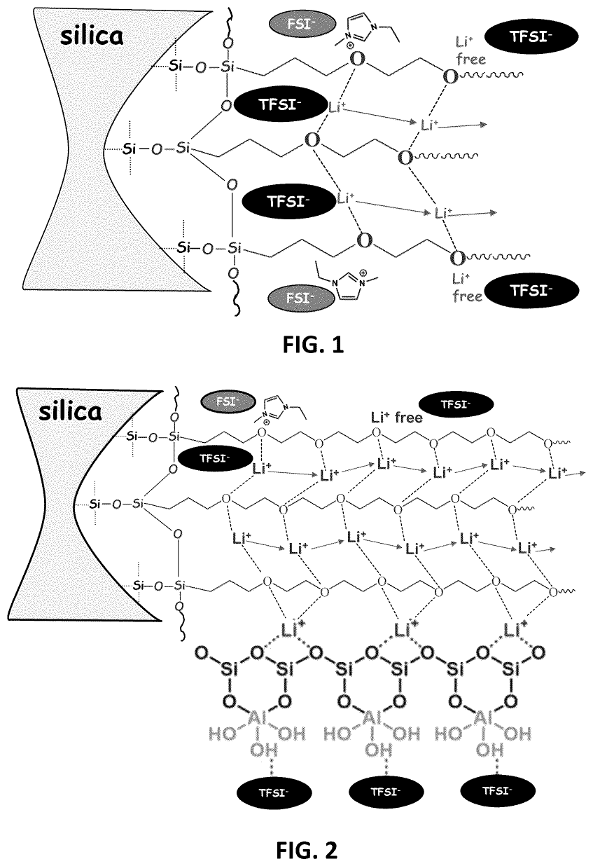

An exemplary graphic representation of an in-situ formation of a composite network consisting of silica and PEG chains is shown in FIG. 1. In particular, a silica scaffold is shown that connects with PEG chains comprising alkoxysilane as terminal reactive functional group in accordance with a preferred embodiment of the electrolyte. As described above, the shown embodiment forms a solid electrolyte having improved flexibility that it less prone to cracking.

In certain embodiments, the amount of polymer precursor compound in the solid electrolyte as described herein is at least 3 wt. % to at most 15 wt. % with respect to the total weight of the electrolyte. It has been found that this may provide an optimal balance between flexibility and integrity of the solid electrolyte.

As mentioned before, the solid electrolyte can be produced with an ionic liquid as an electrolyte. As used herein, “ionic liquids” refers to salts that have a low melting point such that it is liquids at room temperature, comprising a cation and an anion dissolved in a solvent, which depending on the exact anion/cation combination, can be used as electrolytes for energy storage applications.

As will be discussed later, one or more ionically conductive compounds, such as an ionic liquid but also alternatives, such as sulfolane, N-methylacetamide, tetraethylene glycol dimethyl ether, and the like, could be added to the (sol-gel) precursor solution in order to improve the ionic conductivity. Liquid additives with low flammability present high dielectric constant and lead to strong dissociation of the metal salts due to the strong interaction between strongly electronegative groups of the liquid additives and ions, thus providing high ionic conductivity for the solid electrolyte.

Variations of ionically conductive compounds such as ionic liquids are known in the art. For example, as further shown in FIG. 1, the solid electrolyte may comprise 1-Ethyl-3-methylimidazolium bis(fluorosulfonyl)imide (EMIFSI) in accordance with a preferred embodiment of the electrolyte. With the use of EMIFSI, a solid electrolyte can have improved cycle characteristics, rate characteristics, and low-temperature characteristics. Nonetheless, other combinations of conductive compound and metal salts may be considered, as described below.

In some embodiments the metal salt can comprise Li⁺, Na⁺, Mg⁺, Ca⁺, Al⁺, and/or a combination thereof. Preferably the metal salt comprises Lit and/or Nat, which are industry standard for the manufacturing of a high energy solid-state battery. Additionally, a plurality of different metal salts may be used, for example, Li⁺ and/or Na⁺.

In some embodiments the amount of dissolved metal salt may be at least 10 wt. % to at most 20 wt. % with respect to the total weight of the solid electrolyte. Preferably, the amount of dissolved Li salt in the solid electrolyte may be at least 10 wt. % to at most 20 wt. % with respect to the total weight of the solid electrolyte. The listed amounts are advantageous for the manufacturing of a solid-state battery having improved ionic conduction properties.

In some embodiment the amount of dissolved metal salt concentration may be at least 1 Mol/l to at most 2 Mol/l. Preferably, the amount of dissolved LiTFSI may be at least 1 Mol/l to at most 2 Mol/l. Preferably, embodiment the amount of dissolved Li salt concentration may be at least 1 Mol/l to at most 2 Mol/l. Preferably, the amount of dissolved LiTFSI may be at least 1 Mol/l to at most 2 Mol/l. The listed amounts are advantageous for the manufacturing of a solid-state battery having improved ionic conduction properties.

Alternatively or in combination, the lithium salt may comprise one or more other cations, such as Lithium bis(trifluoromethanesulfonyl)imide (LiFSI), Lithium bis(trifluoromethane)sulfonimide (LiTFSI), Lithium hexafluorophosphate (LiPF₆), Lithium tetrafluoroborate (LiBF₄), Lithium bis(oxalato) borate (LiBOB), Lithium nitrate (LiNO₃), any substitutions known in the art, and/or a combination thereof. Nonetheless, LiTFSI is preferred because it is more chemically stable in an organic solvent. Additionally, a plurality of different metal salts may be used, for example, LiFSI and LiTFSI.

In some embodiments, the ionically conductive compound may comprise at least one of an ionic liquid, including 1-Ethyl-3-methylimidazolium bis(fluorosulfonyl)imide (EMIFSI), 1-Ethyl-3-methylimidazolium PrMPyrrTf2N, 1-Ethyl-3-methylimidazolium bis(trifluoromethylsulfonyl)imide (EMITFSI), trifluoromethanesulfonate (EMIOtf), BMATFSI, EMIB(CN)₄, EMITFA, EMIFAP, EMIPF₆, EMIBF₄, BMPYRFSI and/or a combination thereof, sulfolane, N-methylacetamide, Tetraethylene glycol dimethyl ether, mixtures of 1,3-dioxolane (DOL) and 1,2-dimethoxyethane (DME), and/or a combination thereof.

In some embodiments the amount of ionically conductive compound in the solid electrolyte may be at least 1 wt. % to at most 50 wt. % with respect to the total weight of the solid electrolyte. In some embodiments, a molar ratio of the ionic liquid to the composite network silica is at least 0.5 and at most 3 (ionic liquid to silica). The listed amounts are advantageous for the manufacturing of a solid-state battery having improved ionic conduction properties.

Preferably, the solid electrolyte according to the disclosure comprises clay mineral particles. As used herein, clay minerals refers to naturally occurring minerals that are abundant in the Earth's crust. They belong to the phyllosilicate group (i.e., hydrous aluminium phyllosilicates) and are characterized by their layered and crystalline structure. It has been found that clay minerals of a smaller particle size, preferably nanoparticles with a size ranging between 1.0 and 100.0 nm, may provide a higher compatibility between the porous composite network and the clay mineral particles.

The skilled person understands that the origin of the clay mineral particles does not play a significant role in the functioning of the invention. The clay mineral particles may, therefore, be natural clay mineral particles or synthetic clay minerals, e.g., created in industrial settings through various known processes. Nevertheless, the use of natural clay mineral particles, such as natural halloysite nanotubes (HNT), may offer advantages in terms of cost-effectiveness and environmental impact on production.

In preferred embodiments, the clay mineral particles are clay mineral nanoparticles or clay mineral nanostructures. The use of nanoparticles may allow for improved dispersion in the liquid or gel mixture when producing the solid electrolyte using any of the methods described herein. This is particularly important when producing thin layers because any inhomogeneity may impact the ionic conducting properties of the solid electrolyte by interrupting the lithium-ion transport paths. Therefore, producing a solid electrolyte with a homogenous dispersion of clay mineral nanoparticles may further improve overall ionic properties of the solid electrolyte. It may be understood that mixtures of clay mineral particles and clay mineral nanoparticles may also be considered.

In preferred embodiments, the clay mineral particles are clay mineral nanoparticles or clay mineral nanostructures. The use of nanoparticles may allow for improved dispersion in the liquid or gel mixture when producing the solid electrolyte using any of the methods described herein. This is particularly relevant when producing thin layers because any inhomogeneity may disrupt the advantageous lithium-ion transport paths within the solid electrolyte layer. Therefore, producing a solid electrolyte with a homogeneous dispersion of clay mineral nanoparticles may further improve the overall ionic properties of the solid electrolyte. It may be understood that mixtures of clay mineral particles and clay mineral nanoparticles may also be considered.

In preferred embodiments, the clay mineral particles are nanoparticles with a fibrous or tubular structure. This has the advantage that said nanoparticles may simultaneously reinforce the porous composite network and provide a high surface area for interaction with the ionic liquid, which can result in an increase in mechanical strength and ionic conductivity of the solid electrolyte.

In certain embodiments, the clay mineral particles comprise (nano) structures having an elongated shape, such as a fibrous or a needle-like structure. This elongated shape may improve its absorbent and binding properties due to the increased surface area available for interactions. Alternatively, the clay mineral particles can comprise individual nanoparticles that align to an elongated structure. Preferably, the elongated shapes may include nanowires, nanofibers, nanowires, nanotubes, and/or nanorods.

In certain embodiments, the clay mineral particles comprise (nano) structures comprising of rolled or tubular layers, advantageously with a hollow central core or lumen. The external and internal surfaces of the clay mineral particles can be functionalized or modified to enhance compatibility with specific substances such as described in a later embodiment.

In certain embodiments, the clay mineral particles comprises (nano) structures with a tubular shape having a negatively charged exterior and a positively charged interior. Without wishing to be bound by theory, it has been found that the negatively charged exterior of the clay mineral particles is capable of interacting with the metal salt comprised in the ionic liquid. As a result, the clay mineral particles may aid in the dissociation of the metal salt and improve the ionic conductivity of the solid electrolyte. As such, the electrochemical and thermal stability can be enhanced by adding clay mineral particles to the solid electrolyte.

In certain embodiments, the clay mineral particles comprises (nano) structures with a (nano) tubular shape having a hollow interior. Advantageously, the (nano) tubular shape consist of a plurality of rolled layers wherein each layers can comprise at least two different materials. For example, the clay mineral tubular shape may be comprised of rolled alumina and silica layers, the layers may be alternating or successive layers.

In certain embodiments, the clay mineral particles are selected from the group consisting of palygorskite, attapulgite, kaolin, smectite, illite, chlorite, sepiolite, vermiculite, and mixtures thereof; preferably palygorskite, kaolin and/or attapulgite.

In preferred embodiments the amount of clay mineral particles or nanoparticles is at least 0.1 wt. % to at most 10 wt. % with respect to the total weight of the solid electrolyte, preferably at least 0.5 wt. % to at most 10 wt. % with respect to the total weight of the solid electrolyte, more preferably at least 1.0 wt. % to at most 10 wt. % with respect to the total weight of the solid electrolyte. It has been observed that an amount higher than 10 wt % may result in the formation of aggregates that may negatively affect the homogeneous dispersion of the clay mineral particles. Nonetheless, the use of dispersing agents may be considered to address this issue, allowing potentially for a higher wt % of clay mineral particles above 10 wt % to be used.

In certain embodiments the solid electrolyte may comprise halloysite nanotubes (HNT). As used herein, halloysite nanotubes refers to a tubular 3D nanostructure having oppositely charged surfaces, more specifically, a negatively charged external surface, for example silica surface, and a positively charged interior surface, for example aluminol surface. In a preferred embodiment, HNT comprises aluminosilicate (Al₂Si₂O₅(OH)₄).

In preferred embodiments the amount of HNT is at least 0.1 wt. % to at most 10 wt. % with respect to the total weight of the solid electrolyte, preferably at least 0.5 wt. % to at most 10 wt. % with respect to the total weight of the solid electrolyte, more preferably at least 1.0 wt. % to at most 10 wt. % with respect to the total weight of the solid electrolyte. It has been observed that an amount higher than 10 wt % may result in the formation of aggregates that may negatively affect the homogeneous dispersion of HNT. Nonetheless, the use of dispersing agents may be considered to address this issue, allowing potentially for a higher wt % of HNT above 10 wt % to be used.

When free lithium salt is dissolved in a grafted polymer chains of a hybrid electrolyte, it can lead to mobile anions of lithium salt that move freely to the opposite electrode and create concentration gradients in electrolyte, leading to poor lithium-ion transference number, high polarization, large internal impedance and reduction in power capability. The introduction of HNT into the solid electrolyte can immobilize the counter-anions of lithium salt, which may lead to an increase of lithium-ion transference number (tᵤ₊) and simultaneously a reduction of the polarization from the concentration gradient, thereby resulting in a homogeneous lithium deposition and dissolution.

The oppositely charged HNT surfaces can separate lithium salt into lithium cations that are absorbed on the negatively charged outer silica surface, and anions may be accommodated on the positively charged inner aluminol surface. So, an ordered 3D structure for free lithium-ion transport with shorten the distance of free lithium ions transfer, lower ionic coupling and provide a high-speed freeway for lithium-ion transport. Thus improving the ionic conductivity and the lithium-ion transference number of the electrolyte. Additional advantages conferred by the HNT of the composite electrolyte of the invention can include an enhanced mechanical strength, high electrochemical stability window and thermal stability preventing creep under pressure. In this way, HNT may provide the possibility of realizing sustainable high energy storage at a reduced cost.

An exemplary graphic representation of an in-situ formation of a composite network comprising of PEG chains within the porous silica and comprising HNT is shown in FIG. 2. In particular, the EO units on the PEG chains that are grafted within the porous composite network have an abundance of lone-pair electrons that will interact with the Li ions on the outer HNT surface, as the polymer becomes organized and conformed to the HNT. The Lewis acid-base interactions among HNT, Li-TFSI, and PEG effectively order the ions into the 3D channels. As mentioned above, these interactions may significantly shorten the distance of free Li ion transfer.

In some embodiments, the amount of HNT in the solid electrolyte may be at least 0.1 wt. % to at most 10 wt. % with respect to the total weight of the solid electrolyte. The listed amounts are optimal for combining the rigidity of the solid electrolyte with HNT.

In some embodiments, the amount of HNT in the solid electrolyte may be at least 0.1 wt. % to at most 10 wt. %, and the amount of silane terminated polymer, preferably PEG and/or PTHF, is at least 1 wt. % to at most 15 wt. % with respect to the total weight of the solid electrolyte. The listed amounts are optimal for combining the rigidity of HNT with the flexibility of the silane terminated polymer.

Another aspect of the present disclosure relates to a method for producing a solid electrolyte, comprising the steps
mixing a silica precursor, a silane terminated polymer precursor comprising polyethylene glycol (PEG) and/or polytetrahydrofuran (PTHF), an ionically conductive compound, a metal salt, and a solvent to form a liquid mixture;
causing gelation of the liquid mixture to form a gel mixture; and
drying and/or ageing the gel mixture to form the solid electrolyte.

In another aspect, the method for producing a solid electrolyte, preferably a solid electrolyte as disclosed herein, comprises the steps of:
mixing an alkoxide compound, a polymer precursor compound comprising PEG and/or PTHF, an ionically conductive compound, a metal salt, clay mineral particles, and a solvent to form a liquid mixture;
causing gelation of the liquid mixture to form a gel mixture; and,
drying and/or ageing the gel mixture to form the solid electrolyte.

As mentioned before, the solid electrolyte can be produced by reacting an alkoxide compound, preferably a silica precursor with a polymer in any of the above embodiments by a sol-gel process in order to form in-situ porous silica covalently grafted with functionalised polyether chains. It is understood that any of the above embodiments of the solid electrolyte form embodiments for the method for producing the solid electrolyte, and vice versa.

A “sol-gel process” as referred to herein involves the conversion of reactive precursor compounds into a colloidal suspension (sol), which acts as a precursor for an integrated network (gel). In particular, the herein disclosed sol-gel process is a wet-crosslinking technique that may be initiated by hydrolysis and/or alcoholysis of a silicon precursor, optionally in the presence of an organic solvent that can be included, for example, as a second solvent. In accordance with the present disclosure, the colloidal suspension may comprise branched copolymers, and more particularly graft copolymers, wherein the main chain primarily comprises (inorganic) silica, and wherein the side chains primarily comprises the functionalized (organic) polymer chains.

Therefore, in particular embodiments, the liquid mixture used to prepare the solid electrolyte composition as disclosed herein further comprises a solvent. Preferably said solvent comprises water in an amount sufficient for modifying the reactivity of at least a portion of the silicon precursor, preferably by hydrolyzing at least a portion of the silicon precursor. The solvent may aid in the mixing and dispersion of the silicon precursor, the ionic liquid electrolyte (ILE), and the organosilicon compound. Moreover, the solvent may alter the viscosity of the gel mixture and thereby provide easier handling and processing of the gel mixture to form the solid electrolyte composition. Preferably, the solvent comprises an aqueous solvent.

The hydrolysis and/or alcoholysis products comprised in the liquid mixture may condense and cross-link to form dispersed particles in said liquid mixture. Further condensation or curing results in the formation of a three-dimensional network or gel mixture. Subsequently, the wet gel can be dried or aged to form a dry organic-inorganic network, which is preferably free of solvent. When an ionic liquid electrolyte is embedded in said three-dimensional organic-inorganic network, a solid electrolyte is obtained.

In some embodiments, the mixing of the silica precursor and the silane terminated polymer precursor comprises covalently bonding said polymer compound to the silica precursor such that a porous composite network is formed, whereby the silica and silane terminated polymer are covalently grafted within said network.

In some embodiments, the mixing of the alumina precursor and the alkoxy aluminium terminated polymer precursor comprises covalently bonding said polymer compound to the alumina precursor such that a porous composite network is formed, whereby the alumina and alkoxy aluminium terminated polymer are covalently grafted within said network.

In some embodiments, the mixing of the zirconium precursor and the alkoxy zirconium terminated polymer precursor comprises covalently bonding said polymer compound to the zirconium precursor such that a porous composite network is formed, whereby the zirconium and alkoxy zirconium terminated polymer are covalently grafted within said network.

In some embodiments, the polymer precursor compound comprises one reactive functional end group and one non-reactive functional end group according to the following formula:

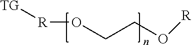

wherein
TG is a reactive functional end group selected from the group consisting of alkoxysilane, alkoxy aluminium, alkoxy zirconium, and combinations thereof;
R is an alkyl group, and
n ranges from 6 to 1300, more preferably 6 to 500, more preferably 6 to 100, more preferably still 6 to 50, more preferably still 6 to 9.

In some embodiments, the polymer compound may comprise a mono-terminal reactive functional group according to the following formula:

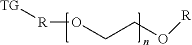

wherein TG is a terminal reactive functional group, R is an alkyl group, and n ranges from 6 to 1300, more preferably 6 to 500, more preferably 6 to 100, more preferably still 6 to 50, more preferably still 6 to 9.

In some embodiments, the polymer precursor compound comprises two reactive functional end groups according to the following formula:

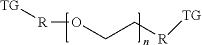

wherein
   TG is a reactive functional end group selected from the group consisting of alkoxysilane, alkoxy aluminium, alkoxy zirconium, and combinations thereof;
   R is an alkyl group, and
   n ranges from 6 to 13000, preferably 6 to 10000, more preferably 6 to 5000, more preferably still 6 to 1000, more preferably still 6 to 500, more preferably still 6 to 150.

In some embodiments, the polymer compound may comprise a bi-terminal reactive functional group according to the following formula:

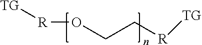

wherein TG is a terminal reactive functional group, R is an alkyl group, and n ranges from 6 to 13000, preferably 6 to 10000, more preferably 6 to 5000, more preferably still 6 to 1000, more preferably still 6 to 500, more preferably still 6 to 150.

In some embodiments, the polymer compound may comprise combination of two or more polymer compounds comprising a different terminal reactive functional group. For example, the polymer compound may comprise two or more polymer compounds comprising a different mono-terminal reactive functional group. Alternatively or in combination, the polymer compound may comprise two or more polymer compounds comprising a different bi-terminal reactive functional group.

In some embodiments, the polymer compound may comprise combination of two or more polymer compounds wherein at least one polymer comprises a mono-terminal reactive functional group, for example, according to any of the above embodiments, and at least one polymer comprises a bi-terminal reactive functional group, for example, according to any of the above embodiments.

In some embodiments, the method as disclosed herein comprises a combination of two or more polymer compounds; wherein at least one polymer comprises one reactive functional end group and one non-reactive functional end group, preferably according to any of the above embodiments, and at least one polymer comprises two reactive functional end groups, preferably according to any of the above embodiments.

In some embodiments, the amount of polymer compound in the liquid mixture, preferably PEG and/or PTHF, is at least 1 wt. % to at most 15 wt. % with respect to the total weight of the solid electrolyte.

In some embodiments, the silica precursor may comprise silicon alkoxide; preferably including tetraethyl orthosilicate (TEOS), tetramethyl orthosilicate (TMOS), triethylvinylorthosilcate (VTEOS), or substitutions thereof, and/or a combination thereof. It may be appreciated that in principle any silicon alkoxide could be considered as a silica precursor in the mixture. The substitution of ethoxy/methoxy group in silicon alkoxide can lead to change in the morphology/propriety of silica obtained, hence allowing some degree of adjustment in the properties of the composite network. The skilled person understands how this selection can be made.

In some embodiments the amount of silica precursor in the liquid mixture can be at least 10 wt. % to at most 25 wt. % with respect to the total weight of the solid electrolyte. The listed amounts are advantageous for the manufacturing of a solid-state battery having good structural properties.

In a particular embodiment, the silica precursor may be omitted from the mixture. The solid electrolyte could be produced based on a combination of precursor compounds that are based on a silane terminated polymer, that is, without the presence of a silicon alkoxide, such as TEOS, VTEOS, or TMOS.

In some embodiments, the ionically conductive compound may comprise at least one of an ionic liquid, including EMIFSI, EMITFSI, PrMPyrrTf2N, EMIOtf, BMATFSI, EMIB(CN)₄, EMITFA, EMIFAP, EMIPF₆, EMIBF₄, BMPYRFSI and/or a combination thereof, sulfolane, N-methylacetamide, Tetraethylene glycol dimethyl ether, mixtures of 1,3-dioxolane (DOL) and 1,2-dimethoxyethane (DME)) and/or a combination thereof. In some embodiments the amount of ionically conductive compound in the liquid mixture may be at least 1 wt. % to at most 50 wt. % with respect to the total weight of the solid electrolyte. The listed amounts are advantageous for the manufacturing of a solid-state battery having improved ionic conduction properties. In some embodiments the metal salt may comprise at least one of Li⁺, Na⁺, Mg⁺, Ca⁺, Al⁺, and/or a combination thereof. Preferably the metal salt comprises Li⁺ and/or Na⁺, which are industry standard for the manufacturing of a high energy solid-state battery.

In some embodiment the amount of dissolved metal salt concentration in the liquid mixture may be at least 1 Mol/l to at most 2 Mol/l. Preferably, the amount of dissolved LiTFSI may be at least 1 Mol/l to at most 2 Mol/l. Preferably, embodiment the amount of dissolved Li salt concentration may be at least 1 Mol/l to at most 2 Mol/l. Preferably, the amount of dissolved LiTFSI may be at least 1 Mol/l to at most 2 Mol/l. The listed amounts are advantageous for the manufacturing of a solid-state battery having improved ionic conduction properties.

Referring back to the gelation method, the liquid mixture can be formed by placing all of the precursor compounds and additives into a container and mixing it with a solvent at low temperature. The solvent may be any organic solvent that is suitable for dissolving the precursor compounds and additives. For example, the solvent may the organic solvent comprises water and/or alcohol, for example isopropanol, ethanol, 1-methoxy-2-propanol, and so on. Advantageously, the liquid mixture is stirred until all components are fully dissolved, for example, by using a magnetic stirrer.

The gel mixture can then be formed by gelation of the liquid mixture. The gelation can be performed by storage in a storage room. For example, a container containing the liquid mixture can be sealed and stored at room temperature (25° C., ambient temperature) for several days, during which the liquid mixture turns into a wet gel mixture.

The time required for the gelation can be controlled by the amount of water added, amount of the organic solvent added, and storage temperature. In some embodiments, the gelation can be performed at a temperature of at most 70° C. to at least 30° C., preferably at most 60° C. to at least 40° C., more preferably at most 55° C. to at least 45° C., more preferably still about 50° C. The listed temperatures can decrease the time needed for gelation to occur, although lower temperatures can be considered still.

After gelation, the solid electrolyte can be formed by drying of the wet gel mixture. The drying can be performed by a classic drying and/or ageing process. For example, the gel mixture can be dried, for example, using a vacuum dryer under the conditions of a pressure of 0.1 to 200 Pa and a temperature of 15 to 100° C. (ambient temperature). Optionally, a pre-drying process may be carried out before the vacuum drying step to reduce occurrence of bumping and generation of air bubbles during the vacuum drying. In the pre-drying process, the gel mixture is heated, for example, using a hot plate provided on a local exhaust system under the conditions of atmospheric pressure and a temperature of 15 to 90° C. (surface temperature of the hot plate). Most of water and the organic solvent contained in the gel mixture can be evaporated by the pre-drying process.

During gelation, the solid electrolyte can be impregnated into the pores of electrode layer. Where a liquid mixture may partially undergo gelation before the impregnation of the electrode layer. The liquid mixture can undergo slight gelation when it is heated at low temperature, then the pre-gelated mixture may be blade coated on the electrode layer, the resultant gel mixture is formed into the pores of active electrode.

Another aspect of the present disclosure relates to an electrode comprising an electrode active material and a solid electrolyte according to any of the above embodiments. In this way, a composite electrode can be obtained. Preferably, the solid electrolyte may cover and/or coat a surface of the electrode active material as a covering/coating layer, as will be described below.

The electrode active material can be, for example, produced by applying a slurry containing active material particles, a binder and conductive agent particles onto a current collector. The slurry can be applied by using a coating technique known in the art, for example, drop casting, blade coating, slot die coating, spray coating, and so on. The slurry can be dried to obtain the electrode active material on top of the current collector.

Subsequently, the electrode active material can be impregnated, for example, by applying a solid electrolyte precursor solution and/or or pre-gelated electrolyte solution onto said electrode active material. In this way, a composite electrode comprising the composite electrolyte can be obtained, with or without an overfill. The impregnation with a solid electrolyte precursor and/or pre-gelated electrolyte solution can be performed by using a coating technique known in the art, for example, drop casting, blade coating, slot die coating, spray coating and the like. The amount of solid electrolyte precursor and/or pre-gelated electrolyte solution can be adapted, for example, to form or not form an overfill on top of the composite electrode. The skilled person understands that the exemplary embodiment can be adapted based on the relevant assembly process strategy.

It may be, moreover, appreciated that, because of the improved properties of the herein disclosed solid electrolyte, there exists the possibility to adapt the production process, for example, to produce a self-standing film, which was previously difficult with other types of solid electrolytes, such as pure porous silica. Nonetheless, the solid electrolyte can also be produced using classic production techniques, as described above, allowing for great adaptability based on the relevant assembly process strategy.

As described above, because the solid electrolyte of the present disclosure can demonstrate an improved ionic conductivity; therefore, an electrode comprising said solid electrolyte can demonstrate improved ionic conduction properties also. Similarly, the electrode can have improved mechanical properties due to the improved flexibility of the solid electrolyte. It is understood that any of the above embodiments of the solid electrolyte form embodiments of the electrode.

The improved structural properties can be particularly advantageous for the manufacturing of an electrode by reducing the chance of the material becoming brittle and breaking. Especially bending and rolling the electrode impregnated with the solid electrolyte and/or covered with an overfill of solid electrolyte becomes feasible. As such, the electrode size may be increased by coating on substrates of larger size and over large areas.

The term “covering” or “coating” is used to refer to a point or position where the electrode active material comes in contact with the solid electrolyte according to any of the above embodiments and results in the formation of a layer that covers and/or coats the electrode active material, more specifically on one or more surfaces thereof. Advantageously, the layer completely covers at least one surface of the electrode active material.

In some embodiments, the solid electrolyte may be a uniform covering/coating layer on the electrode active material. The term “uniform” as used herein referring to the composite layer means that said layer does not contain segregated areas of amorphous and/or crystalline content that can be easily discerned using the analytical techniques described herein.

In some embodiments, the solid electrolyte may be a homogeneous covering/coating layer on the electrode active material. The term “homogeneous” as used herein referring to the composite layer means that the components of said layer, more specifically the silica and polymer compounds in accordance with any of the herein described embodiments, are homogeneously mixed and said layer and/or a surface thereof therefore does not contain areas wherein the components can be easily discerned using the analytical techniques described herein.

In some embodiments the covering layer may have dried thickness, before compression, lower than about 200 μm, preferably lower than about 150 μm; more preferably lower than about 100 μm; more preferably still lower than about 60 μm, for example 50 μm, 40 μm or 30 μm.

In some embodiments the thickness of the covering layer, preferably as excess overfill solid electrolyte, may be between 0 μm and 1000 μm, preferably between 0 μm and 300 μm, more preferably between 0 μm and 100 μm, more preferably still between 0 μm and 30 μm. The thickness of the covering layer can impact the ionic properties of the battery and the skilled person understands that the thickness of the herein described exemplary embodiments can be adapted based on the relevant assembly process strategy.

As used herein, a “thick” film refers to an electrolyte film that, after drying has a layer thickness greater than about 50 μm, and a “thin” film refers to an electrolyte film that, after drying has a layer thickness lower than about 50 μm. Advantageously, the solid electrolyte thickness, after compression, is produced to be as thin as possible while maintaining its mechanical functionality (no cracking) to separate positive and negative electrodes from each other such that the maximum Wh/L can be realised at device and stack level. Nonetheless, it should be appreciated that the herein disclosed composite electrolyte has the advantage of allowing the production of thick/thin films of varying thickness and diameter due to its improved mechanical properties as discussed earlier, making the fabrication of large and/or thick self-standing films possible, or obtaining a crack-free film of few μm (for example, in a range of >20 μm & <150 μm on top of the electrode).

Alternatively or in combination with any of the above embodiments, the solid electrolyte may be a self-standing film. Preferably the solid electrolyte is a homogeneous/uniform self-standing film. Due to the improved mechanical properties of the solid electrolyte, it is possible to cast a film that can be placed onto an electrode, preferably, between two opposite electrodes. The self-standing film can be produced by being deposited on a substrate that is removed after solidification of the solid electrolyte.

In some embodiments the electrode active material used in the electrode can be a positive electrode active material. Examples of the positive electrode active material may include a lithium-containing transition metal oxide, vanadium oxide, chromium oxide, and lithium-containing transition metal sulfide. Examples of the lithium-containing transition metal oxide include LiCoO₂, LiNiO₂, LiMnO₂, LiMn₂O₄, LiNiCoMnO₂ (referred as NMC family with various compositions NMX_{xyz}, where x, y z, refers to the relative amounts of Ni, Mn and Co present in the cathode active material, for example, NMC 111 corresponding to a material composed of Ni 33.33%; Mn 33.3% and Co3.33%; or NMC532, NMC622, NMC 721, NMC811, NMC90.50.5 and any other composition of NMC or combination thereof), LiNiCoO₂, LiCoMnO₂, LiNiMnO₂, LiNiCoMnO₄, LiMnNiO₄, LiMnCoO₄, LiNiCoAlO₂, LiNiPO₄, LiCiPO₄, LiMnPO₄, LiFePO₄, LiMnFePO₄, Li₂NiSiO₄, Li₂CoSiO₄, Li₂MnSiO₄, Li₂FeSiO₄, LiNiBO₃, LiCoBO3, LiMnBO3, and LiFeBO₃. Examples of the lithium-containing transition metal sulfide include LiTiS₂, Li₂TiS₃, and Li₃NbS₄. One positive electrode active material or two or more positive electrode active materials selected from these positive electrode active materials can be used.

In some embodiments the electrode active material used in the electrode can be a negative electrode active material. Examples of the negative electrode active material may include a metal, semimetal, oxide, nitride, and carbon. Examples of the metal and semimetal include lithium, silicon, amorphous silicon, aluminium, silver, tin, antimony, and their alloys. Examples of the oxide can include Li₄TisO₁₂, Li₂SrTi₆O₁₄, TiO₂, Nb₂O₅, SnO₂, Ta₂O₅, WO₂, WO₃, Fe₂O₃, CoO, MoO₂, SiO, SnBPO₆, and their mixtures. Examples of the nitride can include LiCoN, Li₃FeN₂, Li₇MnN₄, and their mixtures. Examples of the carbon include graphite, graphene, hard carbon, carbon nanotube, and their mixtures. One negative electrode active material or two or more negative electrode active materials selected from these negative electrode active materials can be used.

In some embodiments, the electrode may comprise a binder. The binder may fix particles of the electrode active material to each other. When the particles of the electrode active material are fixed to each other, occurrence of a gap due to expansion and shrinkage of the particles of the electrode active material is reduced. This reduces a decrease in the discharged capacity of a battery including the electrode. The binder may, for example, comprise carboxymethyl cellulose (CMC) and styrene-butadiene rubber (SBR), and the like.

Another aspect of the present disclosure relates to a method for producing an electrode, comprising the steps
providing an electrode active material; and
forming a covering/coating layer comprising a solid electrolyte according to any of the above embodiments on the electrode active material.

In some embodiments, the electrode active material can be produced by applying a slurry containing active material particles, a binder and conductive agent particles onto a current collector, and drying said slurry to obtain the electrode active material on top of the current collector. Preferably, the slurry is applied using drop casting, blade coating, slot die coating, and/or spray coating.

In some embodiments, the electrode active material can be impregnated with the solid electrolyte by applying a solid electrolyte precursor solution and/or or pre-gelated electrolyte solution onto said electrode active material, and drying said impregnated electrode active material. Preferably, the impregnation is applied using drop casting, blade coating, slot die coating, and/or spray coating. Advantageously, the amount of solid electrolyte precursor and/or pre-gelated electrolyte solution is adapted based on the relevant assembly process strategy to form or not form an overfill on top of the composite electrode.

In some embodiments, the method may comprise the step of producing a self-standing film comprising the solid electrolyte according to any of the above embodiments, and placing said self-standing film on the electrode active material. Preferably, the self-standing film can be produced by depositing a solid electrolyte precursor solution and/or or pre-gelated electrolyte solution on a substrate and removing said substrate after solidification of said precursor solution.

Another aspect of the present disclosure relates to an electrochemical energy storage device, such as a battery or cell, comprising a positive electrode, a negative electrode and the solid electrolyte according to any of the above embodiments. It is understood that an electrochemical energy storage device may comprise various combinations of electrode, for example, a plurality of negative and positive electrodes that are advantageously stacked on top of each other. Techniques for producing a power storage device from a solid electrolyte are known in the art.

As used herein, an “electrochemical energy storage device” refers to a device capable of either generating electrical energy from chemical reactions or using electrical energy to cause chemical reactions. The technology of the present disclosure can be regarded as general-purpose technology in the sense that it can be readily adapted for a variety of different electrochemical energy storage device, including for example, solid-state electrochemistry which may be implemented in various battery applications, such as automotive, aviation, marine, space, but not limited thereto.

In some embodiments, the electrochemical energy storage device may comprise the solid electrolyte as a self-standing film that is arranged on at least one electrode, preferably, between two opposite electrodes.

As described above, because the solid electrolyte of the present disclosure can demonstrate improved ionic conductivity; therefore, a power storage device comprising an electrode with said solid electrolyte can demonstrate improved ionic conduction properties also. Similarly, the power storage device can have improved mechanical properties due to the improved flexibility of the solid electrolyte comprised in the electrode. It is understood that any of the above embodiments of the solid electrolyte form embodiments of the power storage device.

### EXAMPLES

Examples of an implementation of the technology according to the present disclosure is given hereinbelow. The provision of examples is meant to aid the reader in understanding the technological concepts more easily, but it is not meant to identify the most important or essential features thereof, nor is it meant to limit the scope of the present disclosure.

Throughout the examples, the following abbreviations are used: silane terminated polyethylene glycol (SPEG); halloysite nanotubes (HNT); tetraethoxysilane (TEOS); 1-ethyl-3-methylimidazolium bis(fluorosulfonyl)imide (EMIFSI); Lithium bis(trifluoromethanesulfonyl)imide (LiTFSI); lithium nickel manganese cobalt oxides (NMC) cathode; lithium ferro-phosphate (LFP); thermal gravimetric analysis (TGA); scanning electron microscope (SEM) and electrochemical impedance spectroscopy (EIS).

### Example 1: Mechanical Performance

To demonstrate the improved mechanical properties of the herein disclosed composite electrolyte, a number of solid electrolyte films are produced using drop casting of an electrolyte solution prepared by a sol-gel process based on the following process parameters:
gelation of the liquid mixture at 50° C.;
drop casting of an electrolyte solution in a coin cell cap;
drying the gel mixture at 60° C. under vacuum.

For the liquid mixtures, TEOS is used as the silicon precursor and SPEG is used as the silane terminated polymer precursor to produce a composite porous silica network. Their relative concentrations are specified for each electrolyte film below. HNT is used as the clay mineral particles to include in the composite porous silica network.

For the first part of this example, three different electrolyte films are prepared including pure silica electrolyte (reference), a composite electrolyte with 5.0 wt. % SPEG, and a composite electrolyte with 10.0 wt. % SPEG. The wt. % of SPEG is calculated in comparison to the total weight of the solid electrolyte. The quality of the electrolyte films is visually inspected for the presence of stress cracks.

FIG. 3 shows the results for the pure silica electrolyte film. It can be seen that the solid electrolyte shows a brittle mechanical behaviour leading to stress cracking throughout the coating film.

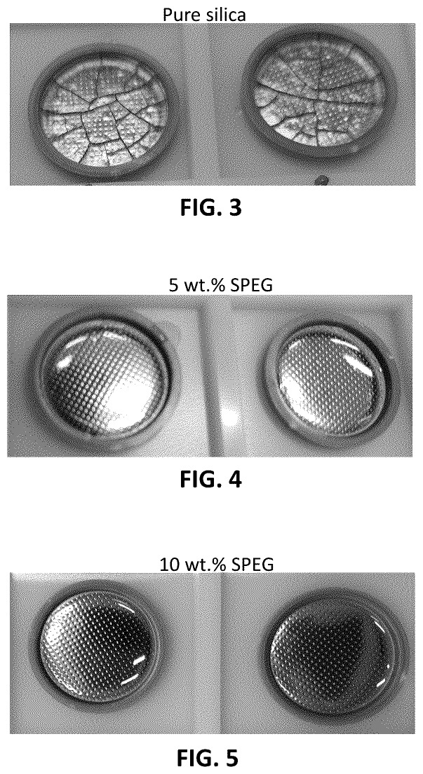

FIG. 4 shows the results for the composite electrolyte film with 5 wt. % SPEG. It can be seen that the composite electrolyte can form a uniform film with improved mechanical properties that does not exhibit any cracks.

FIG. 5 shows the results for the composite electrolyte films with 10 wt. % SPEG. It can be seen that the composite electrolyte can form a uniform film with improved mechanical properties that does not exhibit any cracks.

To further demonstrate the applicability of the electrolyte solution as a self-standing film, two self-standing films are prepared using drop casting of a composite electrolyte solution prepared by the sol-gel process described above, including a composite electrolyte with 5.0 wt. % SPEG and a composite electrolyte with 10.0 wt. % SPEG and 0.5 wt. % HNT.

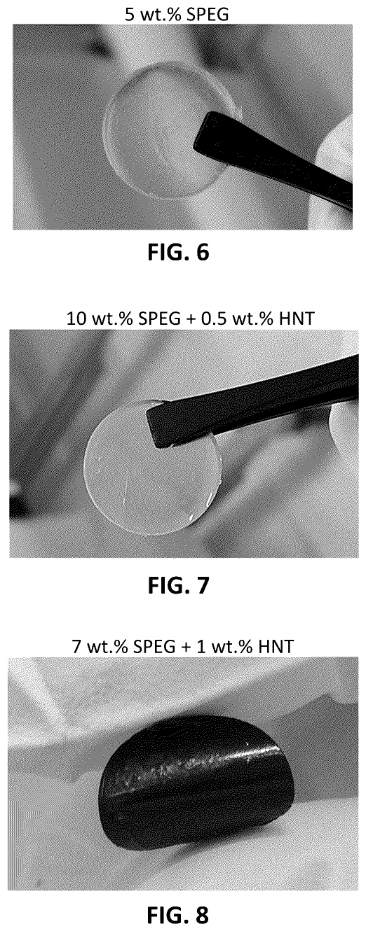

FIG. 6 shows the results for the composite electrolyte film with 5.0 wt. % SPEG. It can be seen that the composite electrolyte can form a stable self-standing film without any cracks.

FIG. 7 shows the results for the composite electrolyte self-standing films with 10 wt. % SPEG and 0.5 wt. % HNT. It can be seen that the composite electrolyte can form a uniform film without any cracks. To further demonstrate the resilience of the solid composite electrolyte when incorporated into and on top of a porous composite electrode, another film is prepared using drop casting of a composite electrolyte solution with 7 wt. % SPEG+1 wt. % HNT. The thickness of the composite electrolyte dried film (dried overfill) on the top of porous composite cathode containing NMC cathode active material is 200 μm. The resilience of the electrolyte film is manually inspected by performing a bending test.

FIG. 8 shows the results for the composite electrolyte film drop casted on top of a porous composite cathode. It can be seen that the 200 μm thick film remains intact after bending, demonstrating a high mechanical stability.

To further understand the applicability of the electrolyte solution as a dried electrolyte film, two electrolyte films are prepared by blade coating of a pure silica electrolyte and a composite electrolyte with 3 wt. % SPEG on top of an NMC cathode. The wt. % of SPEG is calculated in comparison to the total weight of the solid electrolyte. The uniformity of the film is inspected using SEM.

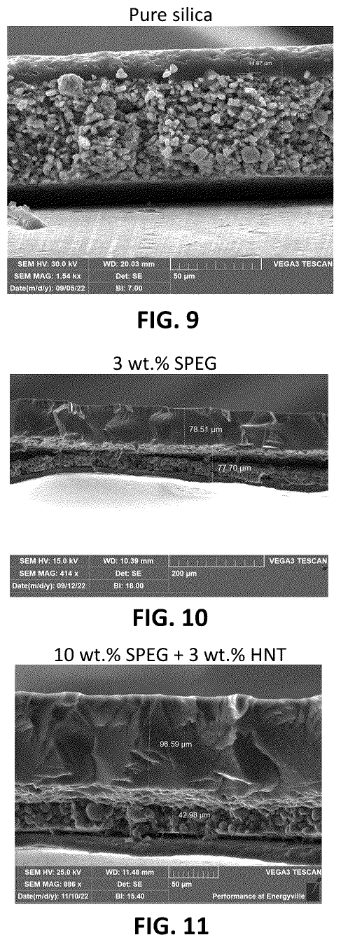

FIG. 9 shows a SEM image for a 14 μm thin film overfill section for the pure silica electrolyte—a section without cracks is selected for the image. It can be seen that the thin film lacks uniformity which may possibly lead to the formation of cracks should the thickness and/or size of the film be increased. This is the thickest pure silica electrolyte film that could be formed without cracks.

FIG. 10 shows a SEM image for a 78 μm thick film overfill section for the composite electrolyte with 3 wt. % SPEG. It can be seen that the film has improved uniformity when compared to the film of FIG. 6, despite the greater thickness. Hence, using silane PEG with silica as composite electrolyte may allow the formation of a self-standing uniform thin/thick film without the formation of any cracks.

FIG. 11 shows a SEM image for a 96 μm thick film overfill section for the composite electrolyte with 10 wt. % SPEG and 3 wt. % HNT. It can be seen that a uniform film without cracks is formed with an even greater thickness.

The above results show that is it possible to form thick (e.g. 78-96 μm) films using composite electrolytes. Such high thickness is impossible to reach using a pure silica electrolyte solution, for which the measured maximum thickness is 14 μm.

### Example 2: Ionic Conductivity Performance

To demonstrate the improved properties of the herein disclosed composite electrolyte, a number of electrolyte films are produced using drop casting of an electrolyte solution prepared by the sol-gel process described in Example 1.

For the first part of this example, five different electrolyte films are prepared including a pure silica electrolyte (reference), composite electrolyte with 5.0 wt. % SPEG, a composite electrolyte with 0.5 wt. % HNT, a composite electrolyte with 7.0 wt. % SPEG and 1.0 wt. % HNT, and a composite electrolyte with 10.0 wt. % SPEG and 0.8 wt. % HNT. The wt. % of SPEG and/or HNT is calculated in comparison to the total weight of the solid electrolyte.

The ionic conductivity of the electrolyte films is characterised using EIS without any pressure applied. Each electrolyte film is sandwiched between a stainless-steel (SS) disk (d=1.5 cm) to form a symmetric [SS/electrolyte/SS] cell.

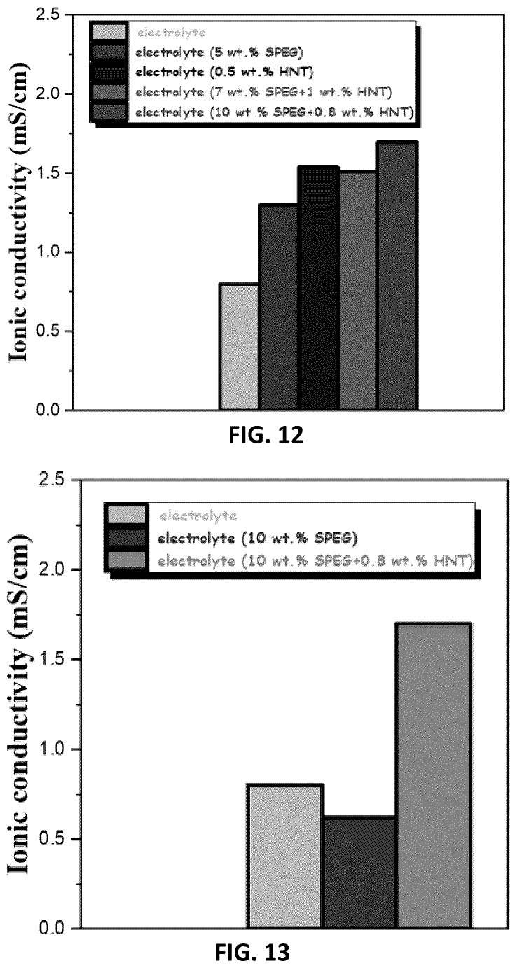

FIG. 12 shows the ionic conductivity (mS/cm) for each electrolyte film. Specifically, for the pure silica electrolyte an ionic conductivity of 0.8 mS/cm is measured, for the composite electrolyte with 5.0 wt. % SPEG 1.3 mS/cm, for the composite electrolyte with 0.5 wt. % HNT 1.53 mS/cm, for the composite electrolyte with 7.0 wt. % SPEG and 1.0 wt. % HNT 1.5 mS/cm, and for the composite electrolyte with 10.0 wt. % SPEG and 0.8 wt. % HNT 1.7 mS/cm.

The above results show that composite electrolyte with different amounts of SPEG and HNT presents higher ionic conductivity compared to pure silica electrolyte. This enhancement in the ionic conductivity can be attributed to the addition of SPEG and/or HNT in the solid electrolyte.

To further demonstrate the improvement in ionic conductivity, three additional solutions are prepared including a pure silica electrolyte (reference), composite electrolyte with 10.0 wt. % SPEG, and a composite electrolyte with 10.0 wt. % SPEG and 0.8 wt. % HNT. The wt. % of SPEG and/or HNT is calculated in comparison to the total weight of the solid electrolyte. The ionic conductivity of the electrolyte films is measured using EIS using the above parameters without any pressure applied.

FIG. 13 shows the ionic conductivity (mS/cm) for each electrolyte film. Specifically, for the pure silica electrolyte an ionic conductivity of 0.8 mS/cm is measured, for the composite electrolyte with 10.0 wt. % 0.62 mS/cm, and for the composite electrolyte with 10.0 wt. % SPEG and 0.8 wt. % HNT 1.7 mS/cm.

The above results show the role of HNT for increasing the ionic conductivity of the composite electrolyte can be observed. It should, however, be noted that for the composite electrolyte with 10 wt. % SPEG there is relatively less Li salt in the solution than for the composite electrolyte with 5 wt. % SPEG. Hence, it may be expected that the ionic conductivity is comparatively lower.

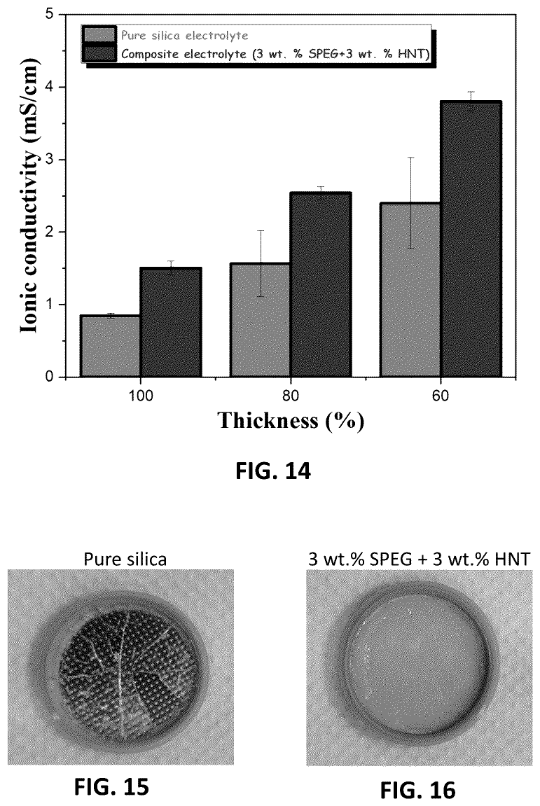

To further demonstrate the applicability of the electrolyte solution as a dried electrolyte film under pressure, two additional solutions are prepared including a pure silica electrolyte (reference) and a composite electrolyte with 3 wt. % SPEG and 3.0 wt. % HNT. The ionic conductivity of the electrolyte films is measured using EIS using the above parameters with varying degrees of compressive pressure applied. FIG. 14 shows the ionic conductivity (mS/cm) for the above electrolyte films in function of different compressive pressure (thickness %). Specifically, for the pure silica electrolyte an ionic conductivity of 0.8 mS/cm is measured without any pressure applied (thickness 100%), 1.56 mS/cm is measured with mild pressure applied (thickness 80%) and 2.39 mS/cm is measured with high pressure applied (thickness 60%). Further, for the composite electrolyte with 3.0 wt. % SPEG and 3.0 wt. % HNT an ionic conductivity of 1.51 mS/cm is measured without any pressure applied (thickness 100%), 2.54 mS/cm is measured with mild pressure applied (thickness 80%) and 3.80 mS/cm is measured with high pressure applied (thickness 60%).

The above results show that the composite electrolyte presents a higher ionic conductivity compared to pure silica electrolyte across all measured pressure ranges.

Additionally, an effort is made to test the electrolyte films from FIG. 14 under very high pressure (thickness 40%). However, this caused a cracking of the pure silica electrolyte. The quality of the electrolyte films after compression of 40%. is visually inspected as detailed below.

FIG. 15 shows the results for the pure silica electrolyte film after compression of 40%. It can be seen that the solid electrolyte is destroyed due to stress cracking propagating throughout the electrolyte film. FIG. 16 shows the results for the composite electrolyte film with 3 wt. % SPEG and 3.0 wt. % HNT after compression of 40%. It can be seen that the composite electrolyte remains intact even after compression of 40%, demonstrating the higher mechanical stability of the composite electrolyte film.

### Example 3: Thermal Performance

To demonstrate the improved thermal properties of the herein disclosed composite electrolyte, a number of electrolyte films are produced using drop casting of an electrolyte solution prepared by the sol-gel process as described in Example 1.

For the first part of this example, three different solutions are prepared including a pure silica electrolyte (reference), pure HNT (reference), and a composite electrolyte with 3.0 wt. % HNT. The wt. % of HNT is calculated in comparison to the total weight of the solid electrolyte. The thermal degradation of the films is measured using TGA. The TGA profile included a heating rate of 5° C./min up to 600° C., run under Nitrogen gas.

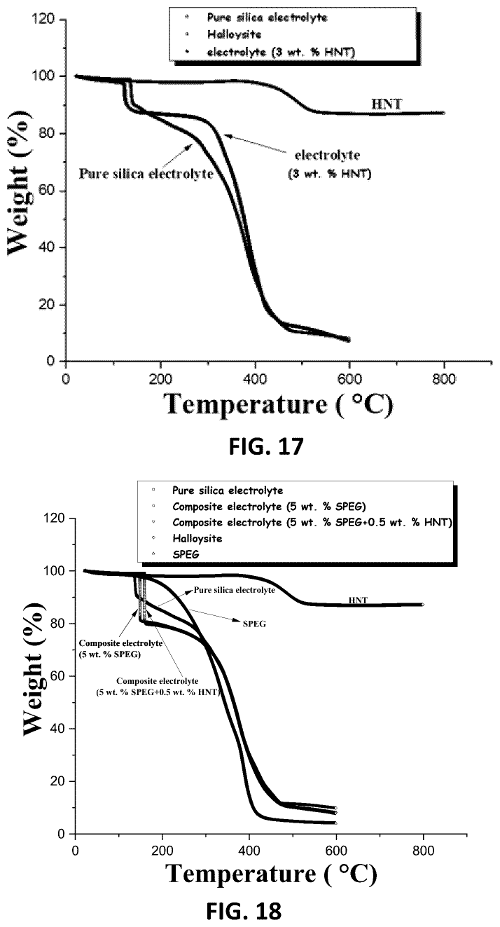

FIG. 17 shows the thermal degradations for the electrolyte films in the temperature range of 0-600° C. Below 123° C., the curves of the three electrolyte films overlap with weight loss of about 2%. Which may be due to the loss of water. The main degradation of the electrolytes from about 123-450° C. corresponds to the decomposition of ionic liquid and LiTFSI. The residuals for the pure silica electrolyte and composite electrolyte are 72% and 84% at 300° C., respectively, which difference of 12% is due to the HNT thermal stability.

The above results show that HNT is stable up to about 400° C. with a weight loss of only 2%. The residual of 87% above 600° C. may be from Al₂O₃ and SiO₂ nanoparticles. Thus, with the addition of HNT, the composite electrolyte still displays strong thermal stability.

For the second part of this example, two additional solutions are prepared including a composite electrolyte with 5.0 wt. % SPEG and a composite electrolyte with 5.0 wt. % SPEG and 0.5 wt. % HNT. The wt. % of SPEG and/or HNT is calculated in comparison to the total weight of the solid electrolyte. Also, the thermal profiles of the pure silica electrolyte, pure SPEG and pure HNT are included as reference. The thermal degradation of the electrolyte films is measured using TGA with the same profile

FIG. 18 shows the thermal degradations for the electrolyte films in the temperature range of 50-600° C. Below 134° C., the curves of the five electrolyte films overlap with weight loss of about 2%. Which may be due to the loss of water. The main degradation of the electrolytes from about 134-450° C. corresponds to the decomposition of SPEG, ionic liquid and LiTFSI. The main thermal degradation of the pure silica electrolyte, composite electrolyte with 5% SPEG and composite electrolyte with 5% SPEG+0.5% HNT started from 134° C., 148° C. and 159° C., respectively, which difference of 14° C. and 25° C. is due to the SPEG and HNT thermal stability.

It can be seen that SPEG and HNT are stable up to about 195° C. and 400° C., respectively, with a weight loss of only 3 and 2%, respectively. Thus, with the addition of SPEG and HNT, the composite electrolytes still display strong thermal stability.

### Example 4: Electrochemical Performance

To demonstrate the improved electrochemical performance of the herein disclosed composite electrolyte, a full cell battery is produced based on a stack of Li metal (200 μm), a self-standing composite electrolyte film (730 μm) with 5.0 wt. % SPEG and 1.0 wt. % HNT, and LiFePO₄. The wt. % of HNT is calculated in comparison to the total weight of the solid electrolyte. The solid electrolyte is prepared using drop casting of an electrolyte solution prepared by the sol-gel process as described in Example 1. The charge/discharge tests on Li/composite electrolyte/LiFePO₄ batteries are performed using a NEWARE battery testing system from 2.5 to 3.8 V at 0.1 C.

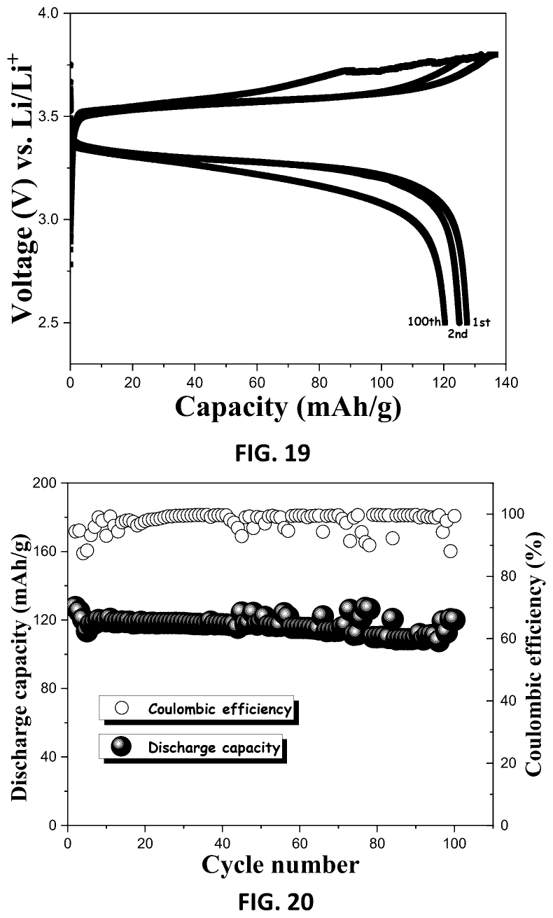

FIG. 19 shows the battery charge/discharge voltage curves for the 1st, 2nd and 100^{th} cycles at a current rate of 0.1 C at room temperature. Typical discharge and charge plateaus are observed, suggesting the good stability for LiFePO₄ during cycling. The initial discharge and charge capacities are 127 mA h/g and 120 mA h/g for the 1st and 100th cycle, respectively.

The potential plateaus of the initial cycle are at 3.5 V for the charging process and 3.34 V for the discharging process for the first cycle indicating a small polarization with the voltage difference between charge and discharge only being 160 mV. The voltage difference increased slightly after 100 cycles, further suggest that the composite electrolyte provides moveable Li ions and a stable interface between electrolyte and electrode

FIG. 20 shows the long-term cycle performance of the battery at room temperature. The Li metal/LiFePO₄ full battery with composite electrolyte works efficiently for long-term cycling (100 cycles) at room temperature and 0.1 C.

The battery which is still cycling presents stable discharge capacities of 120 mA h/g in the 100 discharge/charge cycles, with 95% retention capacity compared to the first discharge capacity, and close to 100% efficiency for each cycle is achieved.

1. A solid electrolyte for an electrochemical energy storage device, comprising a porous composite network obtained by a reaction of an alkoxide compound and a polymer precursor compound;
wherein the alkoxide compound is selected from the group consisting of silica alkoxide, alumina alkoxide, zirconium alkoxide, and mixtures thereof;
wherein the polymer precursor compound comprises two functional end groups of which at least one functional end group is selected from the group consisting of alkoxysilane, alkoxy aluminium, alkoxy zirconium, and combinations thereof;
wherein the polymer precursor compound comprises polyethylene glycol (PEG) and/or polytetrahydrofuran (PTHF);
wherein the porous composite network is functionalised with an electrolyte comprising an ionically conductive compound in which a metal salt is dissolved; and,
wherein the porous composite network comprises clay mineral particles.

2. The solid electrolyte according to claim 1, wherein the clay mineral particles comprise nanoparticles with an elongated shape, preferably including nanowires, nanofibers, nanowires, nanotubes, and/or nanorods.

3. The solid electrolyte according to any one of the preceding claims, wherein the clay mineral particles comprise structures with a tubular or nanotubular shape having a negatively charged exterior and a positively charged hollow interior.

4. The solid electrolyte according to any one of the preceding claims, wherein the clay mineral particles comprise structures with a tubular or nanotubular shape comprising of a plurality of rolled layers, wherein at least rolled two layers comprise a different material.

5. The solid electrolyte according to any one of the preceding claims, wherein the clay mineral particles are selected from the group consisting of palygorskite, attapulgite, kaolin, smectite, illite, chlorite, sepiolite, vermiculite, and mixtures thereof; preferably palygorskite, kaolin and/or attapulgite.

6. The solid electrolyte according to any one of the preceding claims, wherein the clay mineral particles comprise halloysite nanotubes (HNT) comprising aluminosilicate (Al₂Si₂O₅(OH)₄).

7. The solid electrolyte according to any one of the preceding claims, wherein the amount of clay mineral particles is at least 0.1 wt. % to at most 10 wt. %, preferably at least 0.5 wt. % to at most 10 wt. %, with respect to the total weight of the solid electrolyte

8. The solid electrolyte according to any one of the preceding claims, wherein the silica alkoxide is selected from the group consisting of tetraethyl orthosilicate (TEOS), tetramethyl orthosilicate (TMOS), triethylvinylorthosilcate (VTEOS), or substitutions thereof, and/or a combination thereof.

9. The solid electrolyte according to any one of the preceding claims, wherein the alumina alkoxide is selected from the group consisting of aluminium triethoxide, aluminium trimethoxide, aluminium triisopropoxide, or substitutions thereof, and/or a combination thereof.

10. The solid electrolyte according to any one of the preceding claims, wherein the zirconium alkoxide is selected from the group consisting of zirconium tetraethoxide, zirconium tetramethoxide, zirconium tetraisopropoxide, or substitutions thereof, and/or a combination thereof.

11. The solid electrolyte according to any one of the preceding claims, wherein the porous composite network is an inorganic-organic hybrid network, preferably comprising a copolymer of the alkoxide compound and the polymer precursor compound.

12. The solid electrolyte according to any one of the preceding claims, wherein the polymer precursor compound comprises one and/or two reactive functional end groups.

13. The solid electrolyte according to any one of the preceding claims, wherein the amount of polymer precursor compound is at least 3 wt. % to at most 15 wt. % with respect to the total weight of the electrolyte.

14. An electrode comprising the solid electrolyte according to any one of the preceding claims and an electrode active material.

15. The electrode according to claim 14 wherein the solid electrolyte forms a covering and/or coating layer on the electrode active material;
preferably wherein the covering layer is a uniform and/or homogenous covering layer with a preferred layer thickness after drying and before compression of below about 200 μm, more preferably below about 150 μm, more preferably still below about 100 μm; more preferably still below about 60 μm.

16. An electrochemical energy storage device, comprising a positive electrode, a negative electrode; and the solid electrolyte according to any one of claims 1-13;
preferably wherein the solid electrolyte forms a covering and/or coating layer on at least the positive electrode.

17. A method for producing a solid electrolyte, preferably a solid electrolyte according to any one of claims 1-13, comprising the steps of:
mixing an alkoxide compound selected from the group consisting of silica alkoxide, alumina alkoxide, zirconium alkoxide, and mixtures thereof, a polymer precursor compound comprising PEG and/or PTHF, wherein the polymer precursor compound comprises two functional end groups of which at least one functional end group is selected from the group consisting of alkoxysilane, alkoxy aluminium, alkoxy zirconium, and combinations thereof, an ionically conductive compound, a metal salt, clay mineral particles, and a solvent, to form a liquid mixture;
causing gelation of the liquid mixture to form a gel mixture; and,
drying and/or ageing the gel mixture to form the solid electrolyte.

18. The method according to claim 17, wherein the clay mineral particles comprise nanoparticles with an elongated shape, preferably including nanowires, nanofibers, nanowires, nanotubes, and/or nanorods.

19. The method according to any one of claim 17 or 18, wherein the clay mineral particles comprise structures with a tubular or nanotubular shape having a negatively charged exterior and a positively charged hollow interior.

20. The method according to any one of claims 17 to 19, wherein the clay mineral particles comprise structures with a tubular or nanotubular shape comprising of a plurality of rolled layers, wherein at least two layers comprise a different material.

21. The method according to any one of claims 17 to 20, wherein the clay mineral particles are selected from the group consisting of palygorskite, attapulgite, kaolin, smectite, illite, chlorite, sepiolite, vermiculite, and mixtures thereof; preferably palygorskite, kaolin and/or attapulgite.

22. The method according to any one of claims 17 to 21, wherein the clay mineral particles comprise halloysite nanotubes (HNT) comprising aluminosilicate (Al₂Si₂O₅(OH)₄).

23. The method according to any one of claims 17 to 22, wherein the polymer precursor compound comprises one reactive functional end group and one non-reactive functional end group according to the following formula: 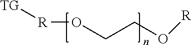
wherein
TG is a reactive functional end group selected from the group consisting of alkoxysilane, alkoxy aluminium, alkoxy zirconium, and combinations thereof;
R is an alkyl group, and
n ranges from 6 to 1300, preferably 6 to 100, more preferably 6 to 9.

24. The method according to any one of claims 17 to 23, wherein the polymer precursor compound comprises two reactive functional end groups according to the following formula: 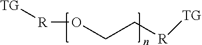
wherein
TG is a reactive functional end group, selected from the group consisting of alkoxysilane, alkoxy aluminium, alkoxy zirconium, and combinations thereof;
R is an alkyl group, and
n ranges from 6 to 13000.

25. The method according to any one of the claims 17-24, comprising a combination of two or more polymer compounds; wherein at least one polymer comprises one reactive functional end group and one non-reactive functional end group, preferably the polymer according to claim 23, and at least one polymer comprises two reactive functional end groups, preferably the polymer according to claim 24.
